(19) United States
(12) Patent Application Publication
(10) Pub. No.: US 2026/0193915 A1
(43) Pub. Date: Jul. 9, 2026

(54) CAP HINGE STRUCTURE OF CHARGING CONNECTOR, AND CHARGING CONNECTOR

(71) Applicant: YAZAKI CORPORATION, Tokyo (JP)

(72) Inventors: Sho Hagita, Kakegawa-shi (JP); Atsushi Takada, Kakegawa-shi (JP)

(21) Appl. No.: 19/442,936

(22) Filed: Jan. 7, 2026

(30) Foreign Application Priority Data
Jan. 8, 2025 (JP) 2025-003006

(51) Int. Cl. E05D 3/02; B60L 53/16; E05C 19/06

(52) U.S. Cl. CPC E05D 3/02; B60L 53/16; E05C 19/063; E05Y 2900/534

(57) ABSTRACT

A cap hinge structure of a charging connector includes a housing including a fitting portion provided with a front opening into which a mating charging connector can be fitted, and a cap for closing the front opening. The cap hinge structure of the charging connector further includes a body attached to the housing of a charging connector. The body includes a cap connection portion to which the cap is connected, and a groove to which an annular seal member is attached.

### CROSS-REFERENCE TO RELATED APPLICATIONS

The present application is based on, and claims priority from the prior Japanese Patent Application No. 2025-003006, filed on January 8, 2025, the entire contents of which are incorporated herein by reference.

### TECHNICAL FIELD

The present disclosure relates to a cap hinge structure of a charging connector, and a charging connector.

### BACKGROUND

A conventionally known charging connector includes a housing including a fitting portion with a front opening into which a mating charging connector can be fitted, and a cap for closing the front opening (see JP2024-89728A). The front opening of charging connector is closed by the cap to prevent the mating charging connector from being fitted into the fitting portion when the fitting portion is not used.

### SUMMARY OF THE INVENTION

The charging connector described above includes a housing that is integral with a hinge part for connecting the cap to the housing. In the charging connector as described above, it is necessary to replace an entire housing that is integral with the hinge part when the hinge part is deformed or damaged due to an excessive force acting on the cap.

It is an object of the present disclosure to provide a cap hinge structure of a charging connector, and a charging connector, which can recover a function of a hinge part without replacing an entire housing by forming the hinge part as a component separate from a housing of the charging connector.

A cap hinge structure of a charging connector according to an embodiment includes a housing including a fitting portion provided with a front opening into which a mating charging connector can be fitted, and a cap for closing the front opening. The cap hinge structure of the charging connector further includes a body attached to the housing of the charging connector. The body includes a cap connection portion to which the cap is connected, and a groove to which an annular seal member is attached.

The charging connector according to an embodiment includes the cap hinge structure.

The configuration described above can provide a cap hinge structure of a charging connector, and a charging connector, which can recover a function of a hinge part without replacing an entire housing by forming the hinge part as a component separate from a housing of the charging connector.

### BRIEF DESCRIPTION OF DRAWINGS

FIG. 1 illustrates a front view of an example of an example charging connector according to the present embodiment.

FIG. 2 is a sectional view taken along line A-A in FIG. 1.

FIG. 3A is an enlarged perspective rear view of a main part of a housing of a charging connector before a hinge part is attached.

FIG. 3B is an enlarged perspective rear view of a main part of a housing of a charging connector after a hinge part is attached.

FIG. 4 is an exploded perspective view of a charging connector according to the present embodiment.

FIG. 5 is an exploded perspective view of a cap and a hinge part.

FIG. 6 is a perspective rear view of a hinge part.

### DETAILED DESCRIPTION OF THE INVENTION

Hereinafter, a cap hinge structure of a charging connector, and a charging connector, according to the present embodiment will be described in detail with reference to the drawings. It should be noted that the dimensional ratios in the drawings are exaggerated for convenience of explanation, and may be different from the actual ratios.

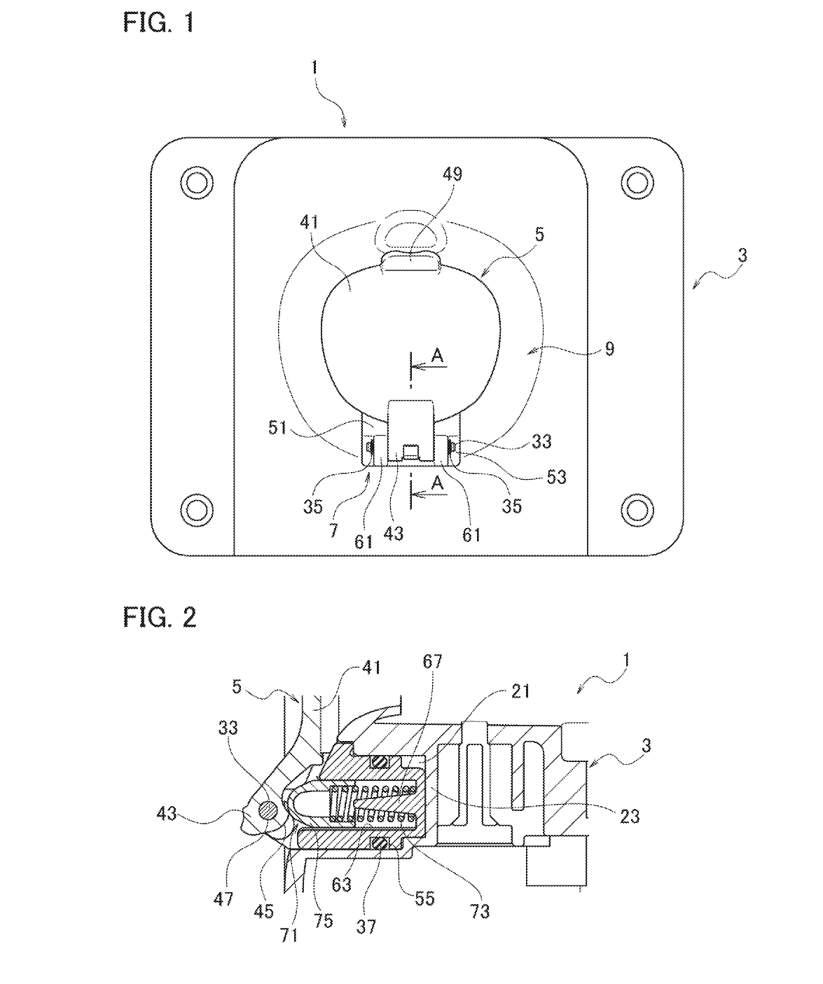

As illustrated in FIG. 1, the charging connector 1 according to the present embodiment is applied to a vehicle charging unit provided in a vehicle, such as an electric vehicle or a hybrid vehicle, for example. The charging connector 1, also referred to as a charging inlet, is electrically connected to a power supply (not illustrated), such as a battery or a storage battery mounted in the vehicle. The charging connector 1 is engaged with a mating charging connector (not illustrated) provided in a power supply facility to charge the power supply.

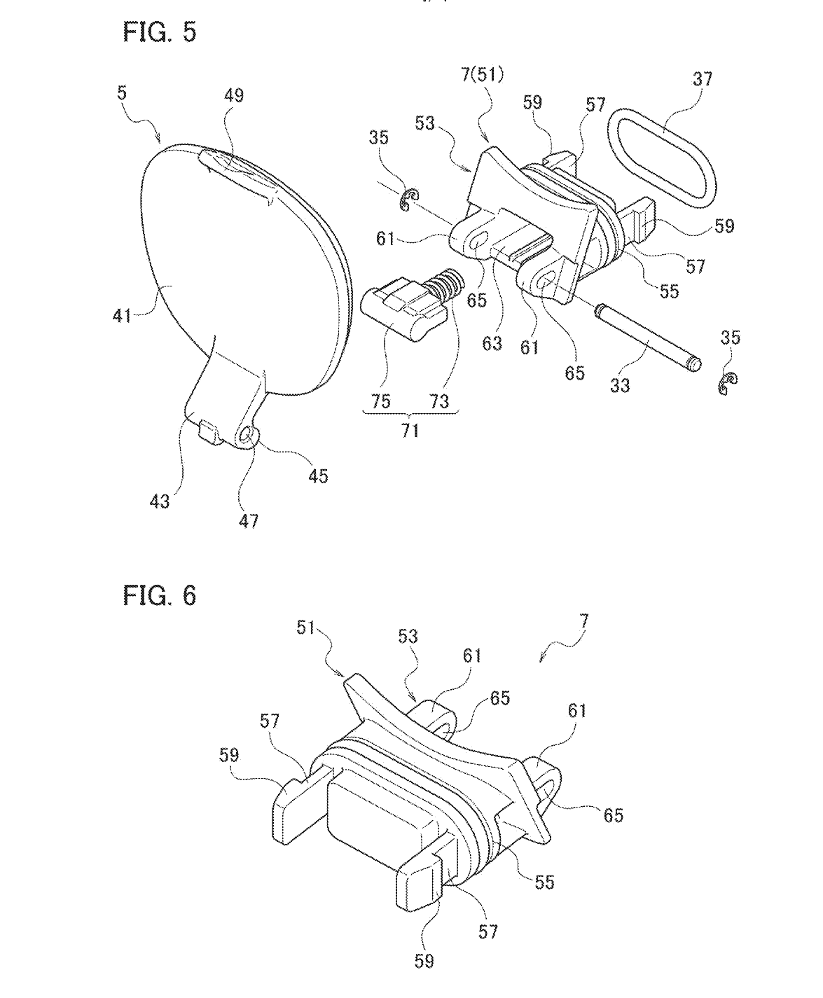

As illustrated in FIGS. 1 to 6, the charging connector 1 includes a housing 3 as an outer housing, a cap 5, and a hinge component 7 as a cap hinge structure.

As illustrated in FIGS. 1 to 4, the housing 3 is made of an insulation material such as a synthetic resin. The housing 3 is provided with a fitting portion 9 into which a mating charging connector can be fitted. The fitting portion 9 includes a fitting outer wall 11 extending in a cylindrical shape in a direction in which the fitting portion 9 is fitted with the mating charging connector. An opening of the fitting outer wall 11 on a fitting surface side thereof constitutes a front opening 13 into which the mating charging connector is inserted.

An inner wall (not illustrated) is formed inside the fitting portion 9, extending in a cylindrical shape in the direction in which the fitting portion 9 is fitted with the mating charging connector. A plurality of terminal reception chambers (not illustrated) are formed inside the inner wall, extending in a cylindrical shape in the direction in which the fitting portion 9 is fitted with the mating charging connector. Both sides of the terminal reception chambers in a longitudinal direction are opened. An opening of a terminal reception chamber on one side in the longitudinal direction constitutes a connection opening into which a mating terminal (not illustrated) of the mating charging connector is inserted when the mating charging connector is fitted into the fitting portion 9. An opening of the terminal reception chamber on the other side in the longitudinal direction constitutes an insertion opening through which a charging terminal (not illustrated) can be inserted into the terminal reception chamber. Charging terminals are received in the plurality of terminal reception chambers each through the insertion openings.

The charging terminals are electrically connected to terminals of electric wires (not illustrated) electrically connected to a power supply. The charging terminals are electrically connected to mating terminals of the mating charging connector by fitting the mating charging connector into the fitting portion 9. The power supply is charged from the power supply facility using an electrical connection between the charging terminals and the mating terminals.

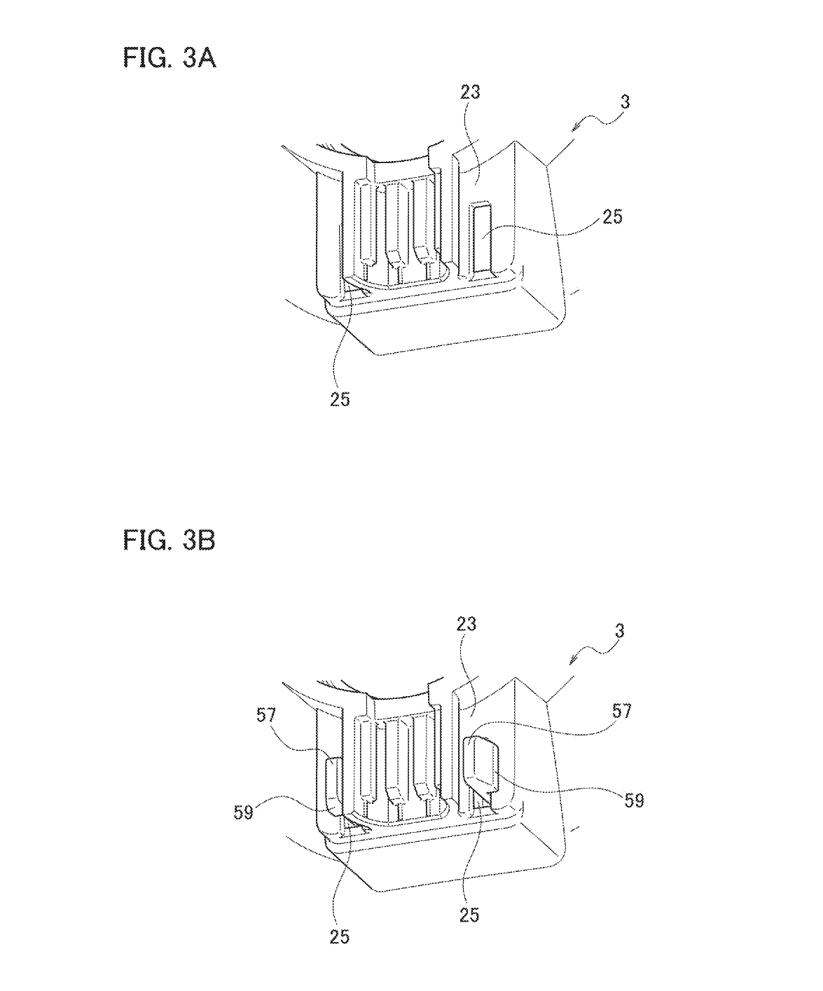

Further, a receiving concave 21 is formed in the housing 3, located below the fitting portion 9, for receiving a body 51 of the hinge component 7 described below. A locking hole 25 for locking a locking piece 57 of the cap 5 is formed in a bottom portion 23 (a flat portion extended in a lateral direction and a vertical direction) of the receiving concave 21 (see FIGS. 2, 3A, and FIG. 3B).

As illustrated in FIGS. 1, 2, 4, and FIG. 5, the cap 5 is made of, for example, an insulation material such as a synthetic resin. The cap 5 includes a plate-like cap body 41 and a shaft support 43 integral with the cap body 41. For example, a grip 49 for a user to grip the cap 5 is provided on a front surface of the cap body 41. The shaft support 43 has a cylindrical shape and extends in the lateral direction. A cam surface 45 is formed around an axial center of the shaft support 43 on an outer surface of the shaft support 43 opposite the side where the cap body 41 is provided. A shaft hole 47 through which a shaft support pin 33 (described below) is inserted is provided in an axial direction of the shaft support 43 (see FIG. 2). The cap 5 is configured to open and close the front opening 13 of the fitting portion 9 (described below) when the shaft support 43 is rotatably attached to a support portion 61.

As illustrated in FIGS. 1 to 6, the hinge component 7 is made of, for example, an insulation material such as a synthetic resin. The hinge component 7 includes a body 51 that is attached to the housing 3 of the charging connector 1. The body 51 includes a cap connection portion 53 to which the cap 5 is connected, and a groove 55 to which an annular seal member (for example, O-ring 37) is attached. The body 51 includes a locking piece 57 which is locked to a locking hole 25 formed in the housing 3 of the charging connector 1. A locking projection 59 is formed at a tip of the locking piece 57 The locking projection 59 and the locking piece 57 are formed continuously with a single piece.

The cap connection portion 53 includes a pair of supports 61 for supporting the shaft support pin 33 and a receiver 63 recessed between the pair of supporting portions 61. Each of the pair of supporting portions 61 includes a shaft support hole 65 through which the shaft support pin 33 is inserted. The shaft support pin 33 inserted into the shaft support holes 65 of the pair of supporting portions 61 is secured against slipping by retaining rings 35 fitted onto both ends.

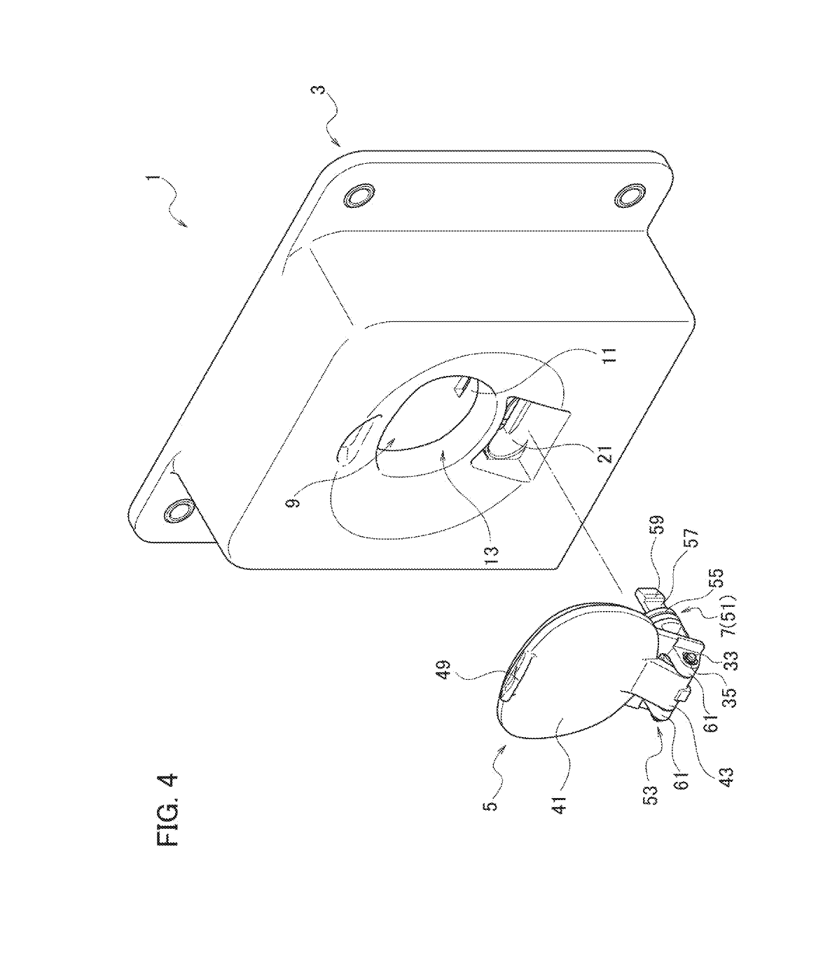

As illustrated in FIGS. 2 and 4, a follower 71 is received in the receiver 63. The follower 71 includes a biasing member (spring 73) and a follower cam (spring holder 75) biased by the spring 73 in the direction of abutting the cam surface 45 of the shaft support 43. A holding portion 67 to which the spring 73 is attached to be held is formed inside the receiver 63 (see FIG. 2). The spring holder 75 attached to a tip of the spring 73 follows rotation of the cap 5 while a tip of the spring holder 75 elastically contacts the shaft support 43 due to an elastic restoring force of the spring 73 received in the receiver 63.

In the charging connector 1 according to the present embodiment, the hinge component 7 formed as a component (structure) separate from the housing 3 serves as a hinge part (cap connection portion 53) for assembling components, such as the cap 5 and the shaft support pin 33. By forming the hinge component 7 as a component separate from the housing 3, the function of the hinge part (cap connection portion 53) can be recovered only by replacing the hinge component 7 even if the hinge part (cap connection portion 53) is deformed or damaged due to excessive force acting on the cap 5. Therefore, replacement of an entire outer housing (housing 3) is unnecessary, and a maintenance cost can be reduced.

The cap hinge structure (hinge component 7) according to the present embodiment include the groove 55 to which a waterproof seal member (O-ring 37) is attached. When the O-ring 37 is attached to the groove 55, waterproof of the housing 3 rearward can be ensured. When the O-ring 37 is not attached to the groove 55, moisture can be discharged from the locking hole 25 formed in the bottom portion 23 of the receiver 63, so that adhesion of the hinge component 7, or the like, caused by the moisture accumulating and freezing inside the receiver 63 can be controlled.

In a conventional general charging inlet, a cap is held by a hinge part integral with an outer housing (housing), and the hinge part needs to be made of the same material as the housing. In the charging connector 1 according to the present embodiment, the hinge component 7, which is a component separate from the housing 3, serves as a hinge part is, so that it is possible to use a material different from the housing 3 for the hinge component 7. For example, effective measures against cracking can be taken when a sticky resin is used for the hinge component 7. In addition, a material that is strong against a load from the shaft support pin 33, a material that gives the shaft support pin 33 a good sliding properties, or the like, can be used for the hinge component 7.

Thus, in the cap hinge structure (hinge component 7) according to the present embodiment, the charging connector 1 includes the housing 3 including the fitting portion 9 provided with the front opening 13 into which a mating charging connector can be fitted, and the cap 5 for closing the front opening 13. The cap hinge structure (hinge component 7) includes the body 51 attached to the housing 3 of the charging connector 1. The body 51 includes the cap connection portion 53 to which the cap 5 is connected, and the groove 55 to which an annular seal member (O-ring 37) is attached.

In the present embodiment, the cap hinge structure (hinge component 7) is a component (structure) separate from the housing 3. Thus, the function of the hinge part (cap connection portion 53) can be recovered only by replacing the hinge component 7 even if the hinge part (cap connection portion 53) is deformed or damaged due to excessive force acting on the cap 5. Therefore, replacement of an entire housing 3 is unnecessary, and a maintenance cost can be reduced.

According to the present embodiment, it is possible to provide a cap hinge structure of the charging connector 1, which can recover the function of the hinge part without replacing the entire housing 3 by making the hinge part as a component separate from the housing 3 of the charging connector 1.

In the cap hinge structure (hinge component 7) of the charging connector 1, the body 51 may include the locking piece 57 which is locked to the locking hole 25 formed in the housing 3 of the charging connector 1.

According to the present embodiment, the body 51 of the hinge component 7 includes the locking piece 57, so that it is possible to improve the attachment of the hinge component 7 (body 51) to the housing 3.

Further, the charging connector 1 according to the present embodiment includes the cap hinge structure (hinge component 7) described above.

In the present embodiment, the hinge part (cap connection portion 53) is a component (structure) separate from the housing 3. Thus, the function of the hinge part (cap connection portion 53) can be recovered only by replacing the hinge component 7 even if the hinge part (cap connection portion 53) is deformed or damaged due to excessive force acting on the cap 5. Therefore, replacement of the entire housing 3 is unnecessary, and a maintenance cost can be reduced.

According to the present embodiment, it is possible to provide the charging connector 1 which can recover the function of the hinge part without replacing the entire housing 3 by forming the hinge part as a component separate from the housing 3 of the charging connector 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A cap hinge structure of a charging connector comprising:
a housing including a fitting portion provided with a front opening into which a mating charging connector can be fitted; and
a cap for closing the front opening, wherein
the cap hinge structure of the charging connector further comprises a body attached to the housing of the charging connector, and
the body includes a cap connection portion to which the cap is connected, and a groove to which an annular seal member is attached.

2. The cap hinge structure of the charging connector according to claim 1, wherein the body includes a locking piece which is locked to a locking hole formed in the housing of the charging connector.

3. A charging connector comprising the cap hinge structure according to claim 1.
